(19) United States
(12) Patent Application Publication
(10) Pub. No.: US 2016/0121418 A1
(43) Pub. Date: May 5, 2016

(54) Welder Powered Arc Starter

(71) Applicant: Gordon Hanka, Beaumont, TX (US)

(72) Inventor: Gordon Hanka, Beaumont, TX (US)

(21) Appl. No.: 14/991,398

(22) Filed: Jan. 8, 2016

Related U.S. Application Data
(63) Continuation-in-part of application No. 13/747,954, filed on Jan. 23, 2013.
(60) Provisional application No. 61/590,766, filed on Jan. 25, 2012.

(51) Int. Cl. B23K 9/067

(52) U.S. Cl. CPC B23K 9/067

(57) ABSTRACT

An electric welding arc starter containing a Tesla coil powered by a switching regulator, which draws its input current from the weld cables. Optionally, the regulator reduces its input current after the Tesla coil fires. Optionally, the regulator temporarily increases its input current before the Tesla coil fires.

| | | | |
|---|---|---|---|
| 1,615,995 | February 1927 | W. Muller | |
| 2,151,786 | March 1939 | R. E. Marbury | 219/8 |
| 3,440,395 | April 1969 | M. Rebuffoni, et al | 219/131 |
| 5,714,731 | February 1998 | Ulrich, et al | 219/130.4 |

### FIELD OF THE INVENTION

My invention relates to electric arc welding, particularly devices which ignite an electric arc.

### BRIEF DESCRIPTION OF DRAWINGS

FIG. 1 depicts a typical arrangement of arc welder and arc starter.

FIG. 2 depicts a boost regulator.

### BACKGROUND OF THE INVENTION

An electric welding arc is harder to ignite than it is to sustain. Consequently, arc welders are commonly augmented with high-frequency arc igniters.

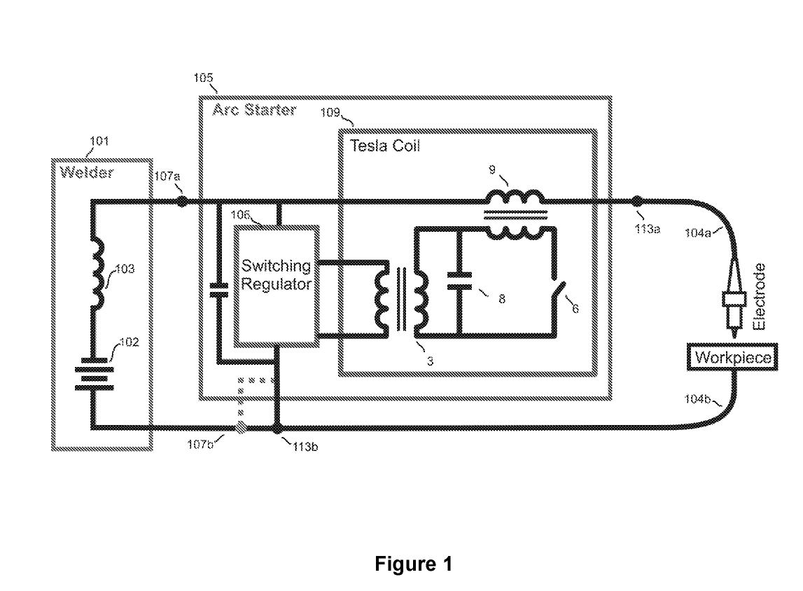

A high-frequency arc igniter augments weld voltage with periodic high-voltage, high-frequency pulses, typically by means of a Tesla coil. The use of a Tesla coil to ignite a welding arc is well known to anyone with ordinary skill in designing welding equipment, and is described in, E.g., Muller (1927) (U.S. Pat. No. 1,615,995), especially Muller's FIG. 1.

I claim Arc Starter 105 depicted in FIG. 1. Arc Starter 105 comprises Tesla coil 109, Switching Regulator 106, and Connectors 107a, 113a-b.

Tesla coil 109 is powered by Regulator 106.

Connector 107b and 113b are in direct electrical communication, and are preferably the same physical object.

Connectors 107a and 113a are in direct electrical communication through the secondary winding of Transformer 9, providing a path for weld current.

In my FIG. 1, the low-numbered components (3-9) correspond to the same-numbered components in FIG. 1 of U.S. Pat. No. 1,615,995.

Transformer 3 charges Capacitor 8. Tesla Coil 109 fires when Switch 6 closes, discharging Capacitor 8 through Transformer 9.

In the preferred embodiment, Switch 6 is a spark gap. However other switch types are feasible, for example an array of IGBT transistors.

Arc Starter 105 works in conjunction with Welder 101. Welder 101 comprises Power Source 102 and Inductance 103, where Inductance 103 includes the stray inductance of Power Source 102, the inductance of any power inputs to 102 (e.g., the electrical mains) plus any inductive reactors as are commonly added to stabilize a DC welding arc. The output of Welder 101 is transmitted to the welding arc by means of Weld Cables 104a-b.

In practice, Arc Starter 105 may be enclosed within Welder 101. However, a stand-alone arc starter has the advantage that it can be used with multiple welders.

In a typical, prior-art arc starter, Arc Starter 105 draws its power from the electrical mains.

A disadvantage of the typical, prior-art, stand-alone arc starter is that it requires a connection to the electrical mains. Preferably the arc starter would draw its power from the weld cables. Such a “welder-powered” arc starter would offer the advantages of (1) Fewer wires and connectors; and (2) Usable with simple, battery- or engine-powered welders in remote areas.

To be most useful, a welder-powered arc starter should accommodate a variety of welders. This is problematic because welder output voltage varies widely. A typical welder, intended for handheld use, may output either AC or DC as high as 130 Vpeak or as low as 45 Vrms. (In rare cases, even lower.) Once a welding arc is established, the welder's output voltage may fall below 20 Vpeak.

U.S. Pat. No. 2,151,786 suggests one scheme for a welder-powered arc starter. In this scheme, Regulator 106 is a passive transformer, powered by the weld cables. The transformer is designed such that its output is sufficient to fire Tesla Coil 109 only when its input voltage (the weld voltage) exceeds the typical voltage across an established arc. This scheme has the advantage that the Tesla coil fires only when the arc is extinguished. This scheme has the disadvantage that a passive transformer requires balanced AC input (that is, AC with roughly equal power in the positive and negative polarities) while many welders provide DC or grossly unbalanced AC. A further disadvantage is that a passive transformer must be large and heavy in order to function at the low frequency (typically 60 Hz) provided by AC arc welders.

A disadvantage of a typical, prior-art arc starter is that its effect dissipates quickly. Experiments reveal that, after a high-voltage spark, arc-path dielectric strength recovers markedly within a few tens of microseconds, which may be too brief for a self-sustaining arc current to rise through Inductance 103. In other words, when the welder has high inductance, it cannot establish a stable arc in the brief window of conductivity created by the arc starter.

Prior-art arc starters typically address this problem by firing rapidly and repeatedly. This has the disadvantage of increasing power consumption, heat generation, wear, and electromagnetic interference.

Alternatively, U.S. Pat. No. 3,440,395 suggests shunting (short-circuiting) Inductance 103 at startup, to allow the weld current to build up quickly. However, this scheme cannot mitigate the (often substantial) stray inductance of Power Source 102 and of the electrical mains.

Alternatively, U.S. Pat. No. 5,714,731 suggests establishing a current through Inductor 103 before firing the Tesla coil, by means of a shunt that connects Weld Cable 104a to 104b. A disadvantage is that the shunt dissipates power that could be used to power the arc starter. A second disadvantage is that the shunt duplicates a function (current draw) that could be performed by the arc starter's power regulator.

My invention also relates to switching regulators. A switching regulator is a voltage regulator that switches power currents on and off at a frequency higher than the frequency of its input current.

Switching regulators are well known to anyone with ordinary skill in electronics. For example, switching regulators are used by most computers.

Switching regulators compete with other types of voltage regulators, primarily linear regulators and passive transformers. A switching regulator offers several advantages.

Relative to a linear regulator, a switching regulator is more efficient. In many applications, including most arc starters, a linear regulator is not practical because it wastes more power than can be dissipated by a reasonable heat sink.

Relative to a passive transformer, a switching regulator offers the following advantages: (1) Smaller; (2) Does not require balanced AC input; and (3) Maintains a stable output voltage across a range of input voltages.

A switching regulator has three main disadvantages. (1) Expensive switches. (2) Complex control logic. (3) Rapidly varying load on the external power source, which in practice must be smoothed with substantial filters.

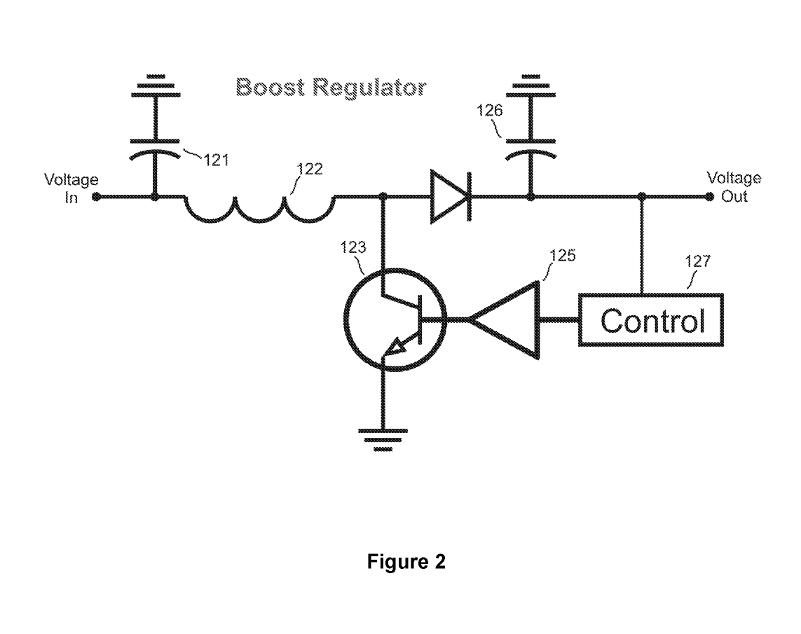

Switching regulators come in many embodiments or “topologies.” The simplest topology is a boost regulator, depicted in FIG. 2.

In FIG. 2, input current passes through Inductor 122 and charges Capacitor 126 to the output voltage. Capacitor 121 smooths input current, which reduces electromagnetic noise and allows the current through Inductor 122 to be varied independent of the input current.

To boost the output voltage above the input voltage, Control 127 periodically turns on Switch 123, which draws additional current through Inductor 122. When Switch 123 turns off, the inductive kick forces current into Capacitor 126.

Typically, Control 127 contains a dedicated boost convertor chip, and/or a general-purpose processor, and circuitry to sense external voltages.

Typically, Control 127 senses the output voltage across Capacitor 126, through a resistive divider. Control 127 then adjusts the duty cycle of Switch 123 in order to equate the divided-down output voltage to a reference voltage. In the prior art, various algorithms are used for adjusting the duty cycle. Such algorithms are well known to anyone with ordinary skill in power supply design, and all tend to increase Switch 123's duty cycle when the output voltage falls below its target. Consequently, a prior-art switching regulator will tend to increase input current immediately after Tesla Coil 109 fires, because firing the Tesla Coil will partially deplete Capacitor 126.

### BRIEF DESCRIPTION OF THE INVENTION

My invention is to power an arc starter from the weld cables, by means of a switching regulator with input power connectors suitable for attachment to weld cables. My invention is further to vary the arc starter's input current to assist arc ignition, by temporarily increasing input current before firing the Tesla coil, and/or temporarily reducing input current after firing the Tesla coil.

### DETAILED DESCRIPTION

In the preferred embodiment, Regulator 106 draws its input power from Connectors 107a and 113b. Input Connector 107b is omitted because it is redundant.

Many types of input connector are suitable for attachment to weld cables, but in the preferred embodiment, the input connectors will be “Quick change” DINSE or Tweco-type connectors, or brass threaded lugs of size ¼″ to ½″. These connectors have the advantage of widespread use, and are familiar to anyone with ordinary skill in welding.

My invention exploits the characteristics of a switching regulator.

In my invention, a switching regulator offers two novel and unexpected benefits.

First, in my invention a switching regulator offers the novel and unexpected benefit of eliminating external power sources, because all input power can be drawn from Tesla Coil 109's pre-existing connection to the weld cables.

Second, my invention offers the novel and unexpected benefit of exploiting two disadvantages of a switching regulator, its complex control logic and its uneven current demand, and turning them into advantages. By modifying Control 127, the switching regulator's input current can be varied to assist arc ignition.

In the method of claim 3, Regulator 106 will temporarily increase its input current before Tesla Coil 109 fires, in order to establish a current through Inductance 103. The precise amplitude and duration of the increase is not critical, but common welders can require on the order of a millisecond to build up weld current. Good results will be obtained by drawing increased input current for two milliseconds, reaching a maximum of five amps.

In the method of claim 2, Regulator 106 reduces its input current after Tesla Coil 109 fires, to avoid drawing current away from the newly established arc. This timing scheme represents the opposite of the prior art, because a prior-art switching regulator would draw maximum input current just after Tesla Coil 109 fires, to replenish the power the Tesla coil drew from Capacitor 126.

In the preferred embodiment of claim 2, Regulator 106 reduces its input current to zero after Tesla Coil 109 fires. The precise duration of reduced input current is not critical, but should be at least one millisecond to ensure establishment of a stable arc current. In the preferred embodiment, Regulator 106 will draw no input current until two milliseconds before the next firing of Tesla Coil 109, in order to maximize the pre-firing current through Inductor 103.

When Regulator 106 reduces its input current, Inductance 103 will create an inductive kick that briefly boosts the weld voltage across Cables 104a-b. The details of this inductive kick will depend on the size of Inductance 103 and Capacitor 121, in relations well known to anyone with ordinary skill in electronics. The inductive kick can assist with arc ignition, especially if timed to coincide with the firing of Tesla Coil 109.

The timing of the inductive kick will vary across welders. Optionally, Control 127 can monitor the voltage across Weld Cables 104a-b, and adjust the timing of Regulator 106's current draw, and/or Tesla Coil 109's firing, so that the inductive kick generates maximum weld voltage when Tesla Coil 109 fires. In the preferred embodiment, weld voltage will not be kicked above 130V, to comply with safety standards for handheld welders.

Alternatively, Regulator 106's current draw can be timed so that the inductive kick generates maximum weld voltage before the planned firing of Tesla Coil 109, in the hopes that the inductive kick will ignite the arc, so that Tesla Coil 109 need not be fired.

In the preferred embodiment, Control 127 includes a general-purpose microcontroller that controls Switch 123 and/or Switch 6, and senses external voltages through resistive networks connected to analog-to-digital converters. Such devices are well known to anyone with ordinary skill in electronic design. In this embodiment, adjusting the timing of Regulator 106's input current, and/or the timing of Switch 6's opening, will require only software modification to Control 127, obvious to anyone with ordinary skill in programming.

“Firing” Tesla Coil 109 may involve multiple openings of Switch 6. For example, good results are obtained from a series of five high-voltage sparks at intervals of 150 microseconds.

In the preferred embodiment, Regulator 106 will operate safely from any input voltage between 20 Vpeak and 130 Vpeak, the voltages typically encountered across weld cables. This design constraint is readily satisfied by means obvious to anyone with ordinary skill in power supply design.

In the preferred embodiment, the voltage across an established welding arc will be sufficient to operate the arc starter in standby mode. Specifically, when input voltage falls to 20 Vpeak (a voltage typical of an established arc) Regulator 106 will still supply enough power to operate auxiliary systems such as cooling fans and user interface. This design constraint is readily satisfied by means obvious to anyone with ordinary skill in power supply design.

In the preferred embodiment, the voltage across an extinguished welding arc will be sufficient to power Tesla Coil 109. Most welders will drive an extinguished arc with voltage in the range 45 Vrms-130 Vpeak. Thus, in the preferred embodiment, Regulator 106 will have sufficient capacity to operate Tesla Coil 109, and any auxiliary systems such as cooling fans and user interface, from input voltage as low as 45 Vrms or as high as 130 Vpeak. This design constraint is readily satisfied by means obvious to anyone with ordinary skill in power supply design.

In the preferred embodiment, Inductor 122 must withstand the high input currents required for input voltages substantially below those of the electrical mains. Consequently, Inductor 122 must be physically larger than would be required by a prior-art, mains-powered arc starter.

In the preferred embodiment, Switch 123 must withstand the high input currents required for input voltages substantially below the electrical mains. Consequently, Switch 123 must have a larger heat sink, and/or lower on-state resistance than would be needed for a prior-art, mains-powered arc starter.

In the preferred embodiment, Regulator 106 and Control 127 comprise a boost regulator, as depicted in FIG. 2. Alternative switching topologies are acceptable, but the boost topology is simplest, and it delivers a high voltage convenient for a Tesla Coil. In practice, additional regulators may be required to supply Control 127 and auxiliary systems such as cooling fans and user interface.

Not shown in the figures are various auxiliary systems, such as cooling fans, user interface, and additional power regulators, as will be obvious to anyone with ordinary skill in electronic design.

I claim:

1. An arc starter apparatus, comprising a Tesla coil, switching regulator, input connectors, and output connectors; said tesla coil is powered by said regulator; said regulator draws input current through said input connectors; said arc starter provides direct electrical paths from said input connectors to said output connectors.

2. A method of using the arc starter apparatus as defined in claim 1, wherein said regulator draws less input current in the 100 microseconds after firing said Tesla coil, relative to the 100 microseconds before said firing.

3. A method of using the arc starter apparatus as defined in claim 1, wherein said regulator draws more input current in the 100 microseconds before firing said Tesla coil, relative to its average input current.
